(19) United States
(12) Patent Application Publication
(10) Pub. No.: US 2006/0283402 A1
(43) Pub. Date: Dec. 21, 2006

(54) Reversible animal collar and leash with decorative inserts

(76) Inventors: Laurence Svennungsen Smith, Santa Clara, CA (US); Geraldine Anne Davis, Santa Clara, CA (US)

Correspondence Address: MICHAEL A. GUTH, 2-2905 EAST CLIFF DRIVE, SANTA CRUZ, CA, 95062, US

(21) Appl. No.: 11/153,063

(22) Filed: Jun. 15, 2005

(51) Int. Cl. A01K 27/00

(52) U.S. Cl. 119/863

(57) ABSTRACT

An animal collar with removable and replaceable inserts for custom ornamentation. An animal leash with removable and replaceable inserts for custom ornamentation, allowing for coordination of the leash and collar in some instances. An animal collar with a leash attach point located to allow for display of the collar ornamentation while the animal leashed. A reversible animal collar with ornamentation on both sides of the collar.

### BACKGROUND

1. Field of the Invention

This invention relates to animal leashes and collars, and more specifically to animal leashes and collars incorporating customized inserts.

2. Description of Related Art

Animal collars may be used for a variety of purposes. Containment collars are used to help control or restrain an animal. Choke collars, harnesses, pronged chain collars, nylon collars, leather collars and the like are used for containment. Training collars are used to help train an animal and also come in many forms. It is also known to topically or transdermally deliver therapeutic agents via a medicinal collar. Flea and tick collars, and anti-asthma collars are examples of medicinal collars.

Identification collars for pets have been known for quite some time. Typically, these items take the form of an elongated strap having at least one end provided with a connecting device, such as a belt buckle, snaps, a clasp, or the like, for connecting the two ends of the strap together to form a loop. In use, the loop is formed around the wearer's neck.

Pet owners typically place a collar, such as described above, around their pets neck for identification purposes. For example, pet collars are known to carry pre-printed or engraved tags carrying identification information, such as the pets name, the owners contact information, etc.

Many owners of pets desire to have decorative collars for their dogs. A problem with many decorative collars is that it is necessary to purchase a complete new collar when the color or design becomes aesthetically unattractive or out of style, or when the owner of the dog desires to change to a collar of a different aesthetic appearance. Another problem with many decorative collars is that the attachment point for a leash is on the opposite side of the animal's neck from the ornamentation. Thus, when a leash is used with the animal, the leash may pull the collar around such that the ornamentation is hidden at the underside of the animal.

What is called for is an animal collar with a variety of decorative options, including a reversible collar with different displays of ornamentation on each side. What is also called for is a collar and leash set that can be custom decorated with inserts that display information or decoration on both sides of the collar and leash.

### SUMMARY

An animal collar with removable and replaceable inserts for custom ornamentation. An animal leash with removable and replaceable inserts for custom ornamentation, allowing for coordination of the leash and collar in some instances. An animal collar with a leash attach point located to allow for display of the collar ornamentation while the animal is leashed. A reversible animal collar with ornamentation on both sides of the collar.

### BRIEF DESCRIPTION OF THE DRAWINGS

FIGS. 1A-C are sketches illustrating a collar according to some embodiments of the present invention.

FIG. 2 illustrates an animal wearing a collar according to some embodiments of the present invention.

FIG. 3 illustrates a side view of an insert according to some embodiments of the present invention.

FIG. 4 illustrates a cross-sectional view of an insert according to some embodiments of the present invention.

FIG. 5 illustrates a cross-sectional view of an insert according to some embodiments of the present invention.

FIG. 6 illustrates a side view of an insert with a leash tab according to some embodiments of the present invention.

FIG. 7 illustrates a leash according to some embodiments of the present invention.

FIG. 8 illustrates a leash according to some embodiments of the present invention.

### DETAILED DESCRIPTION

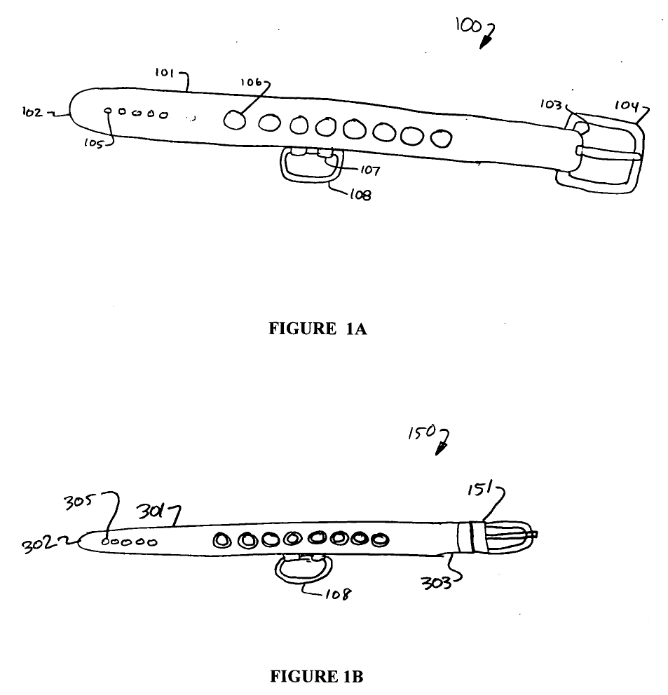

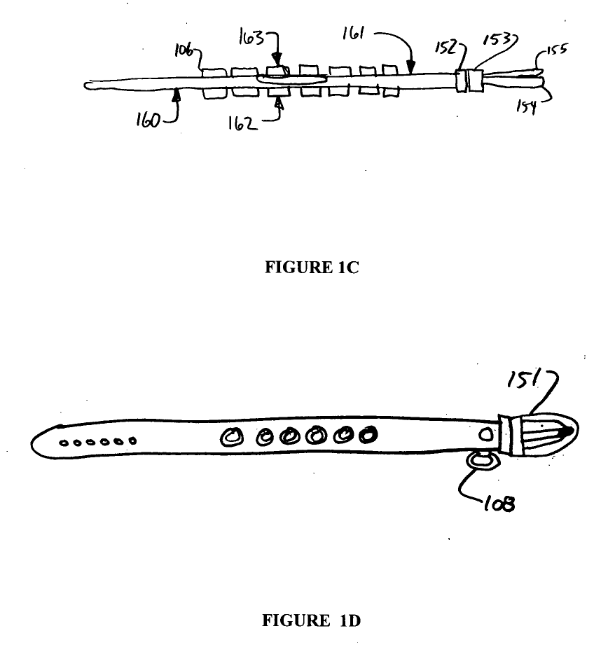

FIG. 1A illustrates an animal collar 100 according to some embodiments of the present invention. An elongated strap 101 has a first end 102 and a second 103. In some embodiments, the elongated strap 101 is made primarily of leather. In some embodiments, the elongated strap 101 is made primarily of nylon webbing. In some embodiments, the elongated strap 101 is made primarily of other suitable material. A buckle assembly 104 is attached to the elongated strap at the second end 103. A set of buckle holes 105 may be situated near the first end 102 of the elongated strap 101. The buckle holes 105 are used in fastening of the buckle assembly 104, and in so doing form the elongated strap 101 into a loop which may go around an animal's neck. In some embodiments, different types of buckles or strap fasteners are used. In some embodiments, a buckle is used which may be fastened from either side, to facilitate a reversible aspect of the animal collar 100.

A leash ring 108 is attached to the elongated strap 101 using one or more leash ring holders 107 in some embodiments. The leash ring 108 may be attached to the elongated strap 101 at approximately the mid-point of the elongated strap. The leash ring 108 may be attached at the approximate mid-point of a buckled collar in some embodiments. Typically, the leash attached to an animal collar pulls the collar around such that the leash attach point is on the top of the animals neck. With a leash having decorative aspects, this may pull the decorative aspects, which may be predominantly in the middle part of the collar, down and around to the bottom of the animal's neck and may hide the decorative aspects from view. With a leash attach point near or at the middle portion of the collar, the pull of the leash will not tend to hide the decorative aspects of the collar mounted near the middle of the collar.

A plurality of inserts 106 are attached into the elongated strap 101 in some embodiments. The inserts 106 may be mounted through holes in the elongated strap 101 in some embodiments. In some embodiments, the decorative studs may have decoration on each side of the collar, allowing for a change of decoration by simply reversing the collar. Thus, with a reversible buckle, the collar may flipped over in order to display a different set of decorations.

FIGS. 1B and 1C illustrate an animal collar 150 according to some embodiments of the present invention. An elongated strap 301 has a first end 302 and a second 303. In some embodiments, the elongated strap 301 is made primarily of leather. In some embodiments, the elongated strap 301 is made primarily of nylon webbing. In some embodiments, the elongated strap 301 is made primarily of other suitable material. A reversible buckle assembly 151 is attached to the elongated strap at the second end 303. A set of buckle holes 305 may be situated near the first end 302 of the elongated strap 301. The buckle holes 105 are used in fastening of the reversible buckle assembly 151, and in so doing form the elongated strap 301 into a loop which may be fastened around an animal's neck.

The reversible buckle assembly 152 may have a first part 152 that is fastened to the elongated strap 301 at the second end 303. A second part 153 of the reversible buckle assembly 151 may be attached to the first part 152 and may rotate at least 180 degrees such that the buckle loop 154 and the buckle stay 155 may fasten around an animal's neck with a different side of the elongated strap 301 facing outwards.

The elongated strap 301 has a first side 160 and a second side 161. In some embodiments, the first side 160 may be of a different color, and may also have different thread colors showing, and may also have different embossing or other design features than the second side 161 of the elongated strap 301. In some embodiments, the elongated strap 301 may consist of two or more layers, such that the first side 160 is of a layer of one material, and the second side 161 is of a layer of a second material.

A plurality of inserts 106 are attached into the elongated strap 301 in some embodiments. The inserts 106 may be mounted through holes in the elongated strap 301 in some embodiments. The inserts 106 may have recesses allowing for the placement of decoration in to the faces of the inserts. Although the inserts are decorative in the sense that they provide mounting for a decorative portion, the inserts may of sufficient strength that they are structural as well. A first side 162 of the studs 106 may be part of a decorative scheme on the first side 160 of the elongated strap 301, and the second side 163 of the studs 106 may be part of a decorative scheme on the second side 161 of the elongated strap 301. Thus, with a reversible buckle assembly 151, the collar may flipped over on the animal in order to display a different set of decorations, but still be able to be fastened in the usual fashion.

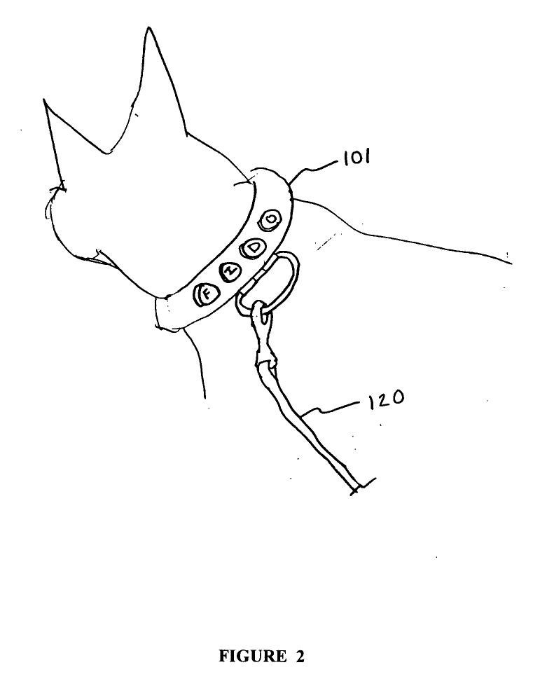

FIG. 2 illustrates a collar in use on an animal. The elongated strap 101 has been buckled around the animal's neck into a loop. A leash 120 has been fastened to the collar. The leash ring is on the upper, top portion of the animal's neck, allowing the decorative studs to be more visible.

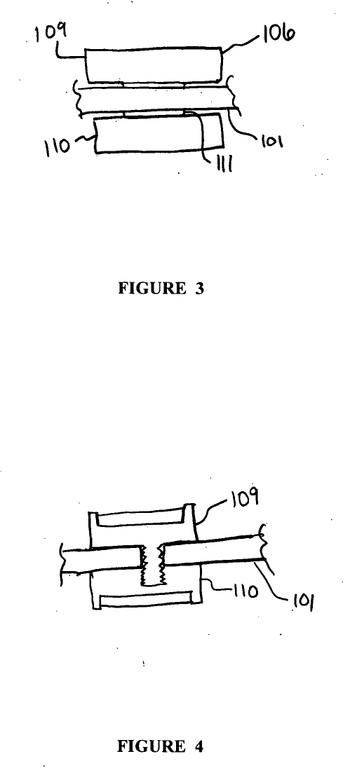

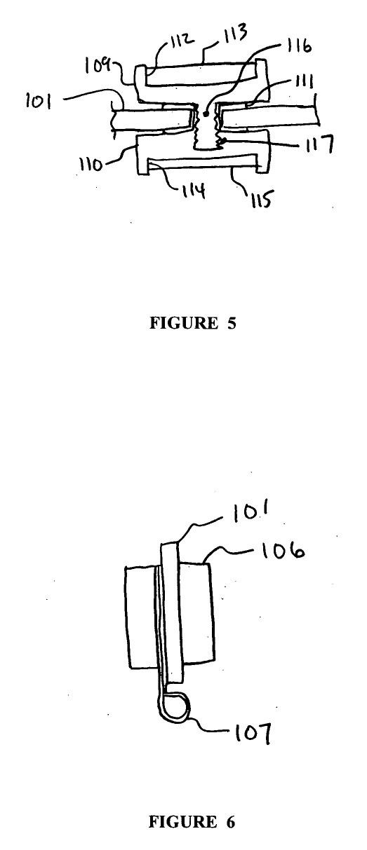

FIG. 3 illustrates a side view of the elongated strap 101 and a decorative insert 106 according to some embodiments of the present invention, also seen in cross-section in FIG. 5. The decorative insert 106 has a male portion 109 and a female portion 110. A grommet 111 has been attached to the elongated strap 101 around a through hole. In some embodiments, the grommet may be a self-piercing grommet. The male portion 109 has had its threaded stud 116 inserted through the strap, and through the center of the grommet, to thread into the threaded hole 117 in the female portion 110. In some embodiments, the male portion 109 and the female portion 110 are made of aluminum. In some embodiments, the male portion 109 and the female portion 110 are made of metal or plastic. The grommet 111 allows for the decorative stud 106 to clamp around the grommet instead of the collar strap in some embodiments.

The male portion 109 may have a recess 109 which is filled with a decorative portion 113. A decorative design, or a letter, or other graphic object may be placed in the recess. The decorative design may be on paper or other material, and may be bonded into the bottom of the recess. A clear layer may then be placed over the decorative design in some embodiments. The clear layer may be a self-healing urethane in some embodiments. The female portion 110 may have a recess 114 which is filled with a decorative portion 115. The decorative inserts may be slightly recessed in the recesses in some embodiments. The decorative insert may display an artistic rendering or a letter or other item. The recessing of the decorative insert into the recess reduces the likelihood of scratching of the top surface of the decorative insert. The use of a material such as a self-healing urethane allows for “scratching” of the surface and subsequent healing of the scratch. The recessing may also be used for aesthetic purpose.

FIG. 4 is a cross-sectional view of a decorative insert mounted on a collar without a grommet. The male portion 109 and the female portion 110 are threaded together and capture the elongated strap 101. In some embodiments, with or without grommets, the male portion 109 and the female portion 110 may use a shoulder such that threads can be places under tension without putting pressure on the collar.

FIG. 6 illustrates a side view of the mounting of a leash ring holder 107 according to some embodiments of the present invention. The decorative stud 106 captures the leash ring holder 107 along side the elongated strap 101 in some embodiments. The leash ring holder may be a metallic strip formed into a double backed overlapping strap with an opening for the leash ring in some embodiments. One or more leash ring holders may used to attach a leash ring to the collar. In some embodiments, the leash ring holder may form a substantially circular cross-section in which the leash ring is held. In some embodiments, the center of the circular cross-section may line up with the centerline of the elongated strap. Thus, when the collar is reversed, the position of the leash ring relative to the plane of the elongated strap remains substantially constant.

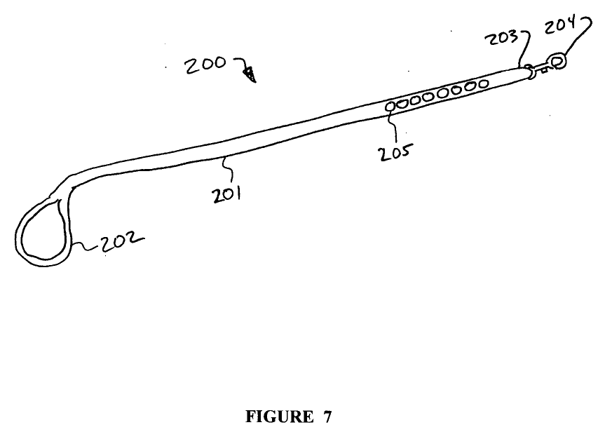

FIG. 7 illustrates a leash 200 according to some embodiments of the present invention. In some embodiments, the leash 200 has a strap portion 201 with a handle 202. The handle 202 may be a loop of the strap material in some embodiments. In some embodiments, the strap may be made of leather. In some embodiments, the strap may be made of nylon webbing or other suitable materials. The collar end 203 of the strap portion 201 may have a clip 204 for attachment of the leash 200 to an animal collar.

The leash 200 may have one or more decorative inserts 205 mounted in to the strap portion 201 according to earlier described embodiments of the invention. The leash mounted decorative inserts allow for display of decorations, names, or other items on the leash itself. The decorative inserts on the leash may be coordinated with the decorative inserts on the collar to achieve an aesthetic aim.

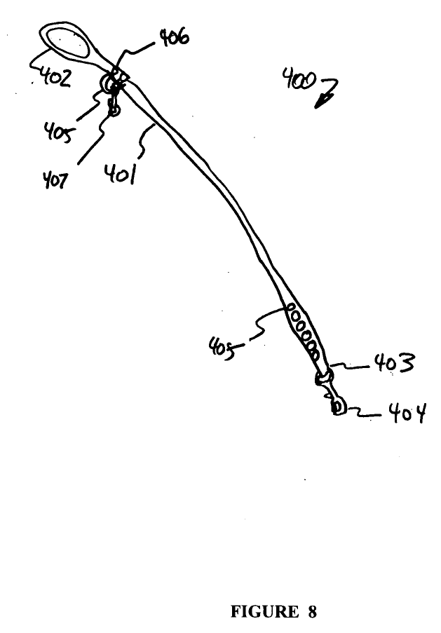

In some embodiments of the present invention, as seen in FIG. 8, a leash 400 has a strap portion 401 with a handle 402. The handle 402 may be a loop of the strap material in some embodiments. In some embodiments, the strap may be made of leather. In some embodiments, the strap may be made of nylon webbing or other suitable materials. A plurality of decorative inserts 405 may be attached to the strap portion of the leash. The collar end 403 of the strap portion 401 may have a first clip 404 for attachment of the leash 400 to an animal collar. A ring 405 may be attached to the strap portion 401. In some embodiments, the ring 405 is attached to the strap portion 401 adjacent to the handle 402. The ring allows a use who may be walking their dog, for example, to attach personal items such as keys to the leash. In some embodiments, the ring 405 is attached to the strap portion 401 with inserts 406. In some embodiments, the ring 405 is attached to the strap portion 401 by being sewn in to the leash, between folds of the leash or handle material, for example. In some embodiments, a second clip 407 is attached to the ring. The second clip 407 allows for the clipping on of personal items, for example, of the user.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. An animal collar comprising:
an elongated strap, said elongated strap comprising:
a first end;
a second end; and
a central strap portion extending between said first end and said second end; and
a detachably engagable buckle attached to said elongated strap substantially near said first end, said detachably engagable buckle adapted to attach said first end to said elongated strap substantially near said second end thereby forming a loop; and
a leash attach ring, said leash attach ring attached to said central strap portion near the mid-point of the central strap portion.

2. The animal collar of claim 1 further comprising a plurality of holes in said central strap portion, said plurality of holes substantially along the centerline of said central strap portion.

3. The animal collar of claim 2 further comprising a plurality of inserts, said inserts attached to the central strap portion through the plurality of holes.

4. The animal collar of claim 3 wherein each of said inserts comprises a male portion and a female portion, said male portion comprising a threaded stud, said female portion comprising a threaded hole, said threaded stud mounted through one of said plurality of holes.

5. The animal collar of claim 4 wherein said male portion has a top side opposite that of the threaded stud, said top side comprising a recess.

6. The animal collar of claim 5 wherein said recess is at least partially filled with a decorative portion.

7. The animal collar of claim 4 wherein said female portion has a top side opposite that of the threaded hole, said top side comprising a recess

8. The animal collar of claim 7 wherein said recess is at least partially filled with a decorative portion

9. The animal collar of claim 1 wherein said collar further comprises:
a first decorative side; and
a second decorative side.

10. An animal collar comprising:
an elongated strap, said elongated strap comprising:
a first end;
a second end; and
a central strap portion extending between said first end and said second end; and
a reversible buckle attached to said elongated strap substantially near said first end, said reversible buckle adapted to attach said first end to said elongated strap substantially near said second end thereby forming a loop, said reversible buckle adapted to rotate at least 180 degrees with regard to said elongated strap; and
a leash attach ring, said leash attach ring attached to said central strap portion near the mid-point of the central strap portion.

11. The animal collar of claim 10 further comprising a plurality of inserts, said inserts attached to the central strap portion through a plurality of holes.

12. The animal collar of claim 11 wherein said inserts have a first end and a second end, and wherein said first end and said second end have a mounting surface for a decorative portion.

13. The animal collar of claim 11 wherein each of said inserts comprises a male portion and a female portion, said male portion comprising a threaded stud, said female portion comprising a threaded hole, said threaded stud mounted through one of said plurality of holes

14. The animal collar of claim 13 wherein said inserts have a first end and a second end, and wherein said first end and said second end have a mounting surface for a decorative portion.

15. The animal collar of claim 14 wherein said mounting surfaces are recessed into said first ends and said second ends of said inserts.

16. The animal collar of claim 12 wherein said mounting surfaces are recessed into said first ends and said second ends of said inserts.

17. An animal collar comprising:
an elongated strap, said elongated strap comprising:
a first end;
a second end; and
a central strap portion extending between said first end and said second end; and
a reversible buckle attached to said elongated strap substantially near said first end, said reversible buckle adapted to attach said first end to said elongated strap substantially near said second end thereby forming a loop, said reversible buckle adapted to rotate at least 180 degrees with regard to said elongated strap; and
a leash attach ring, said leash attach ring attached to said central strap portion.

18. The animal collar of claim 17 further comprising a plurality of inserts, said inserts attached to the central strap portion through a plurality of holes.

19. The animal collar of claim 18 wherein said inserts have a first end and a second end, and wherein said first end and said second end have a mounting surface for a decorative portion.

20. The animal collar of claim 17 wherein said leash attach ring is attached to said central strap portion adjacent to said first end of said central strap portion.

21. An animal collar comprising:
an elongated strap, said elongated strap comprising:
a first end;
a second end; and
a central strap portion extending between said first end and said second end; and
a detachably engagable buckle attached to said elongated strap substantially near said first end, said detachably engagable buckle adapted to attach said first end to said elongated strap substantially near said second end thereby forming a loop;
a plurality of holes in said central strap portion, said plurality of holes substantially along the centerline of said central strap portion;
a plurality of decorative inserts, said decorative inserts attached to the central strap portion through the plurality of holes, wherein each of said decorative inserts comprises a male portion and a female portion, said male portion comprising a threaded stud, said female portion comprising a threaded hole, said threaded stud mounted through one of said plurality of holes.

22. The animal collar of claim 21 wherein each of said decorative inserts comprises a male portion and a female portion, said male portion comprising a threaded stud, said female portion comprising a threaded hole, said threaded stud mounted through one of said plurality of holes.

23. The animal collar of claim 22 wherein said male portion has a top side opposite that of the threaded stud, said top side comprising a recess.

24. The animal collar of claim 23 wherein said recess is at least partially filled with a decorative portion.

25. The animal collar of claim 22 wherein said female portion has a top side opposite that of the threaded hole, said top side comprising a recess

26. The animal collar of claim 25 wherein said recess is at least partially filled with a decorative portion

27. An animal leash comprising:
an elongated strap, said elongated strap comprising:
a first end;
a second end; and
a central strap portion extending between said first end and said second end;
a plurality of holes in said central strap portion, said plurality of holes substantially along the centerline of said central strap portion;
a plurality of decorative inserts, said decorative inserts attached to the central strap portion through the plurality of holes, wherein each of said decorative inserts comprises a male portion and a female portion, said male portion comprising a threaded stud, said female portion comprising a threaded hole, said threaded stud mounted through one of said plurality of holes;
a handle at said first end of said elongated strap; and
a clip, said clip attached at said second end of said elongated strap.

28. The animal leash of claim 27 wherein said male portion has a top side opposite that of the threaded stud, said top side comprising a recess.

29. The animal leash of claim 28 wherein said recess is at least partially filled with a decorative portion.

30. The animal leash of claim 29 wherein said decorative portion does not completely fill said recess.

31. The animal leash of claim 27 wherein said female portion has a top side opposite that of the threaded hole, said top side comprising a recess

32. The animal leash of claim 31 wherein said recess is at least partially filled with a decorative portion

33. An animal leash comprising:
an elongated strap, said elongated strap comprising:
a first end;
a second end; and
a central strap portion extending between said first end and said second end;
a handle at said first end of said elongated strap;
a first clip, said first clip attached at said second end of said elongated strap; and
a ring, said ring attached to said elongated strap.

34. The animal leash of claim 33 wherein said ring is attached to said elongated strap adjacent to said handle.

35. The animal leash of claim 33 further comprising a second clip, said second clip attached to said ring.
